(19) United States
(12) Patent Application Publication
(10) Pub. No.: US 2025/0219486 A1
(43) Pub. Date: Jul. 3, 2025

(54) MOTOR

(71) Applicant: MINEBEA MITSUMI Inc., Nagano (JP)

(72) Inventors: Junichi MIYAKI, Kitasaku-gun (JP); Yutaka KAMOGI, Kitasaku-gun (JP)

(21) Appl. No.: 18/850,385

(22) PCT Filed: Mar. 31, 2022
(86) PCT No.: PCT/JP2022/016457

§ 371 Date: Sep. 24, 2024

(51) Int. Cl. H02K 1/276; H02K 1/18; H02K 21/16

(52) U.S. Cl. CPC H02K 1/2773; H02K 1/185; H02K 21/16

(57) ABSTRACT

A motor includes a shaft, a stator, and a rotor. The rotor includes a yoke and a magnet. The yoke includes an annular part, a magnetic pole part, a connection part, and a gap. The annular part is disposed at an inner side in a radial direction. The magnetic pole part is disposed at an outer side in a radial direction and is in contact with the magnet. The connection part connects the annular part and the magnetic pole part. The gap is formed between the magnetic pole part and the connection part in the circumferential direction. The magnetic flux at the inner diameter side of the magnet passes through an outer peripheral surface of the magnetic pole part.

### TECHNICAL FIELD

The present invention relates to a motor.

### BACKGROUND ART

For an inner rotor type motor, a rotor provided with plate-shaped magnets magnetized in front and back directions is known. The plate-shaped magnets are disposed at the rotor in the form of spokes in a radial direction such that two adjacent plate-shaped magnets repel each other.

### CITATION LIST

### Patent Literature

Patent Document 1: WO 2018/070226

Patent Document 2: JP 2013-529054 A

Patent Document 3: JP 2021-158795 A

### SUMMARY OF INVENTION

### Technical Problem

This type of rotor may have difficulty in guiding a magnetic flux in an inner diameter side part of the plate-shaped magnet to a coil disposed at a radially outer side.

In one aspect, an object is to provide a motor capable of improving motor characteristics.

### Solution to Problem

In one aspect, a motor includes a shaft, a stator, and a rotor. The rotor includes a yoke and a magnet. The yoke includes an annular part, a magnetic pole part, a connection part, and a gap. The annular part is disposed at an inner side in a radial direction. The magnetic pole part is disposed at an outer side in a radial direction and is in contact with the magnet. The connection part connects the annular part and the magnetic pole part. The gap is formed between the magnetic pole part and the connection part in a circumferential direction. A magnetic flux at the inner diameter side of the magnet passes through an outer peripheral surface of the magnetic pole part.

According to one aspect, motor characteristics can be improved.

### BRIEF DESCRIPTION OF DRAWINGS

FIG. 1 is a perspective view illustrating an example of a motor according to a first embodiment.

FIG. 2 is a cross-sectional view illustrating an example of the motor according to the first embodiment.

FIG. 3 is a cross-sectional view illustrating an example of a yoke provided with magnets according to the first embodiment.

FIG. 4 is a cross-sectional view illustrating an example of the yoke according to the first embodiment.

FIG. 5 is an enlarged cross-sectional view illustrating an example of the yoke provided with the magnet according to the first embodiment.

FIG. 6 is an enlarged cross-sectional view illustrating an example of an expansion part and an annular part of the yoke according to the first embodiment.

FIG. 7 is an enlarged cross-sectional view illustrating an example of a leading end part of the yoke and an extending part of the magnet according to the first embodiment.

FIG. 8 is a cross-sectional perspective view illustrating an example of a rotor according to the first embodiment.

FIG. 9 is a cross-sectional perspective view illustrating an example of a cover according to the first embodiment.

FIG. 10 is a view explaining an example of a flow of a magnetic flux according to the first embodiment.

FIG. 11 is a graph showing an example of a relationship between a size of a gap and motor characteristics according to the first embodiment.

FIG. 12 is a view explaining an example of a flow of a magnetic flux according to a comparative example.

FIG. 13 is a view explaining an example of a flow of a magnetic flux according to another comparative example.

FIG. 14 is a graph showing an example of a relationship between a length of the radius of a leading end part of the magnetic pole part and the motor characteristics according to the first embodiment.

FIG. 15 is a graph showing an example of a relationship between a length of the radius of a branch part and the motor characteristics according to the first embodiment.

FIG. 16 is a graph showing an example of a relationship between a length of the extending part of the magnet and the motor characteristics according to the first embodiment.

FIG. 17 is a graph showing an example of a relationship between a length of the leading end part of the magnetic pole part and the motor characteristics according to the first embodiment.

### DESCRIPTION OF EMBODIMENTS

An embodiment of a motor disclosed herein will be described below in detail with reference to the drawings. Note that the dimensional relationship between elements and the scale of each element in the drawings may differ from reality. The drawings may include parts with dimensional relationships and scales different from each other between drawings. In each of the drawings, a coordinate system including at least any one of an axial direction (rotation axis direction of a motor 1 to be described later), a radial direction, or a circumferential direction of the motor 1 may be illustrated for the purpose of facilitating explanation. In addition, the rotation axis direction of the motor 1 may be simply referred to as an “axial direction” below.

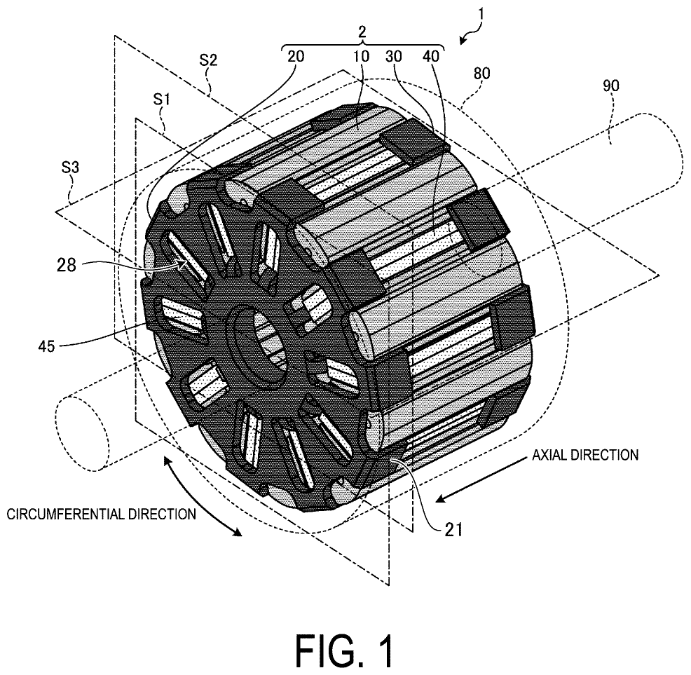

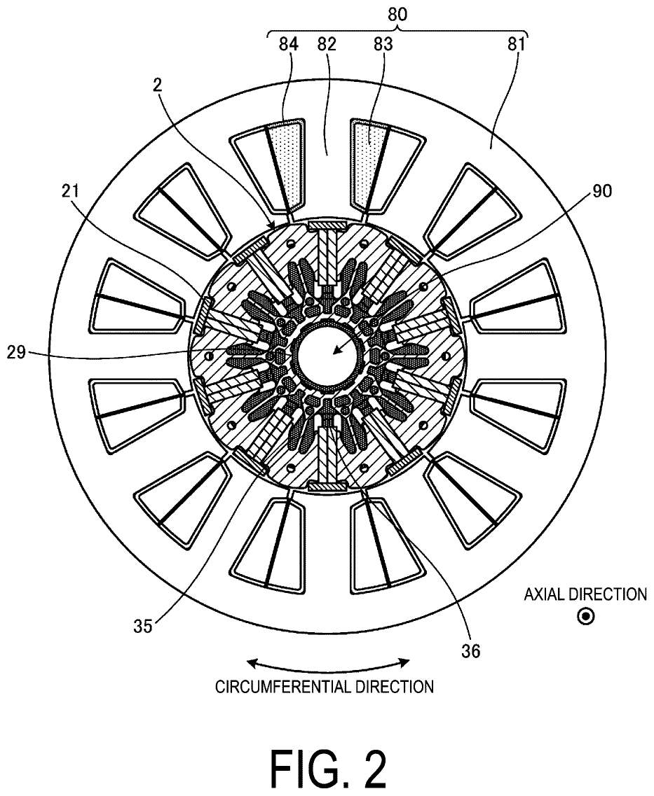

First, the motor 1 according to the embodiment will be described with reference to FIGS. 1 and 2. FIG. 1 is a perspective view illustrating an example of the motor according to the first embodiment. FIG. 2 is a cross-sectional view illustrating an example of the motor according to the first embodiment. FIG. 2 illustrates a cross-section taken along plane S1 in FIG. 1. As illustrated in FIG. 1, the motor 1 according to the present embodiment includes a shaft 90, a rotor 2, and a stator 80. Note that the motor 1 described in each embodiment is, for example, an inner rotor type brushless motor. In the inner rotor type brushless motor, the stator 80 is located at a radially outer side of the rotor 2. Further, the motor 1 according to each embodiment is accommodated in, for example, a frame (not illustrated).

As illustrated in FIG. 2, the stator 80 includes a yoke 81, teeth 82, coils 83, and insulators 84. The yoke 81 is an annular member formed at an outer peripheral side of the stator 80. The teeth 82 project toward the radially inner side from the yoke 81. The yoke 81 and the teeth 82 are formed by, for example, punching the shape illustrated in FIG. 2 out of a flat plate-shaped member made of a magnetic material, such as a magnetic steel plate, and stacking a plurality of the punched members in the axial direction. The coils 83 are wound around the teeth 82 via the insulators 84, for example.

As illustrated in FIGS. 1 and 2, the rotor 2 is rotatably inserted into the radially inner side of the stator 80. The rotor 2 includes a yoke 10 and a plurality of magnets 40. The rotor 2 according to the embodiment further includes covers 20 and 30 covering the yoke 10 in the axial direction. For example, the shaft 90 is inserted into the radially inner side of the rotor 2 via inner peripheral parts 29 and 39 of the covers 20 and 30, respectively, and thus the shaft 90 is positioned at the radially inner side of the rotor 2. The covers 20 and 30 will be described in more detail below.

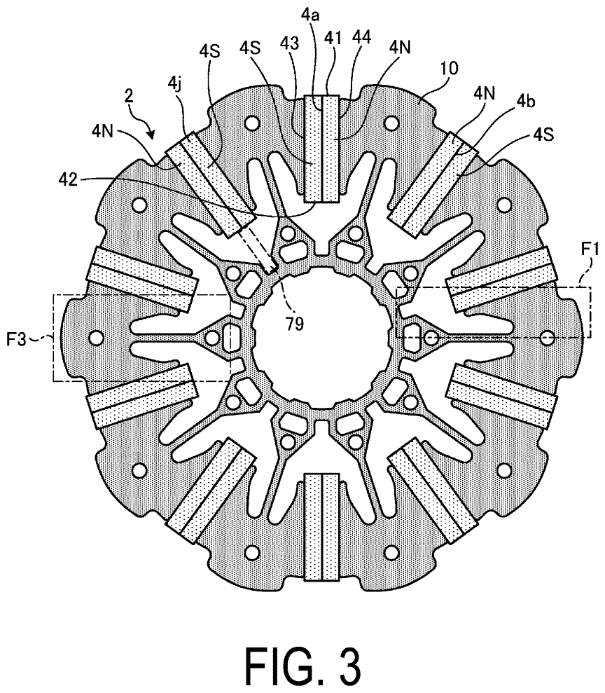

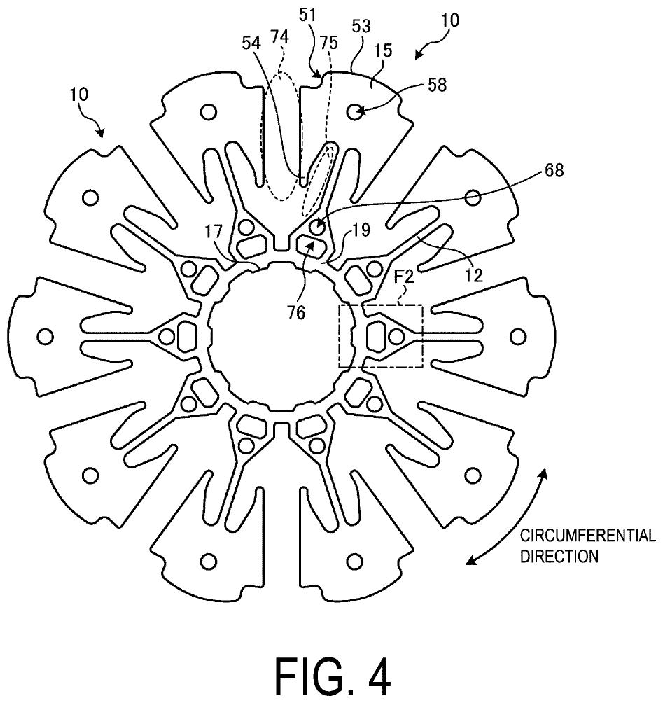

The yoke 10 has a stacked structure obtained by stacking a plurality of steel plate cores made of a soft magnetic material such as a silicon steel plate. FIG. 3 is a cross-sectional view illustrating an example of the yoke provided with the magnets according to the first embodiment. FIG. 4 is a cross-sectional view illustrating an example of the yoke according to the first embodiment. FIGS. 3 and 4 illustrate a cross-section taken along plane S2 in FIG. 1.

As illustrated in FIG. 4, the yoke 10 includes an annular part 19, a plurality of magnetic pole parts 15, connection parts 12, and gaps 75. In addition, the yoke 10 may further include rivet parts 58 and 68 for stacking the steel plate cores.

The annular part 19 is disposed at the radially inner side of the yoke 10. The magnetic pole parts 15 are disposed at a radially outer side of the yoke 10 and are in contact with the magnets 40. The connection part 12 connects the annular part 19 and the magnetic pole part 15. In the embodiment, the plurality of magnetic pole parts 15 extend toward the radially outer side from the connection parts 12. The plurality of magnetic pole parts 15 are formed in line in a circumferential direction.

Each of the magnetic pole parts 15 includes a leading end part 54 projecting in an inner diameter direction and an outer peripheral surface 53 extending in the circumferential direction. Further, a recessed part 51 cut out in the circumferential direction and the radial direction is formed at both end parts of the outer peripheral surface 53 in the circumferential direction. Note that, as illustrated in FIG. 4, the rivet part 58 is formed, for example, near the center of the magnetic pole part 15.

In the embodiment, as illustrated in FIG. 4, a pair of leading end parts 54 is formed at the magnetic pole part 15 in the circumferential direction. The leading end parts 54 extend, for example, in a direction of extension of the magnet 40. As illustrated in FIG. 3, the leading end part 54 is in contact with the magnet 40 in the circumferential direction. In the embodiment, at the position illustrated in FIG. 3, the magnet 40 opposes the annular part 19 of the yoke 10 via an air layer 79 in the radial direction.

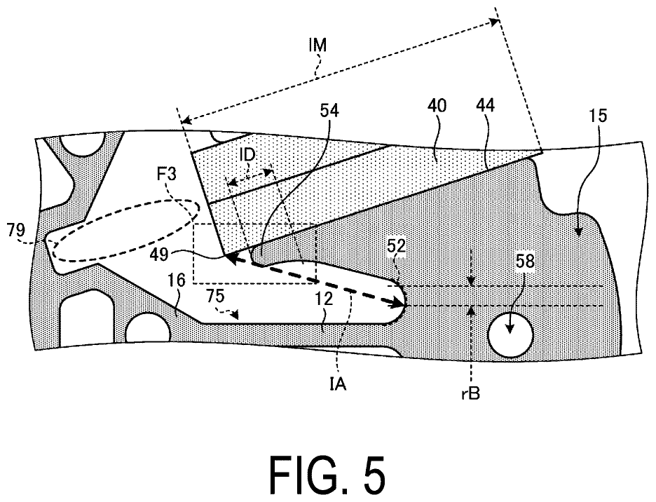

Further, the connection part 12 extends in the radial direction. As illustrated in FIGS. 4 and 5, the outer peripheral side of the connection part 12 branches off from the inner peripheral side of the magnetic pole part 15. FIG. 5 is an enlarged cross-sectional view illustrating an example of the yoke provided with the magnet according to the first embodiment. FIG. 5 is an enlarged view of the part indicated by frame F1 in FIG. 3. As illustrated in FIG. 5, the connection part 12 branches off from the magnetic pole part 15 at a branch part 52 and connects the annular part 19 located at the radially inner side and the magnetic pole part 15. Note that the branch part 52 is an example of a part of the connection part separated from the magnetic pole part.

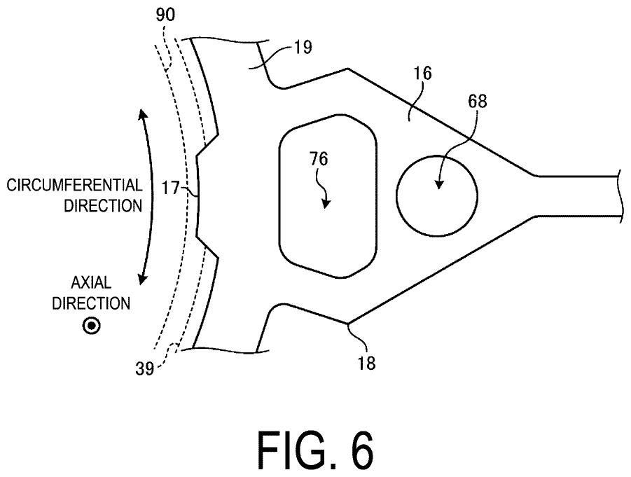

In addition, as illustrated in FIGS. 5 and 6, the connection part 12 includes an expansion part 16. FIG. 6 is an enlarged cross-sectional view illustrating an example of the expansion part and the annular part of the yoke according to the first embodiment. FIG. 6 is an enlarged view of the part indicated by frame F2 in FIG. 4. Note that the expansion part 16 is an example of a part expanding toward the radially inner side in the circumferential direction.

The expansion part 16 expands toward the radially inner side in the circumferential direction and is connected to the annular part 19. Note that, as illustrated in FIG. 6, the expansion part 16 may include parts 18 bent in the circumferential direction. The rivet part 68 is formed near the center of the expansion part 16.

In addition, the annular part 19 includes a projecting part 17 projecting toward the radially inner side. As illustrated in FIG. 6, the projecting part 17 projects toward the shaft 90 located at the radially inner side. As illustrated in FIG. 6, end surface in an inner peripheral side of the projecting part 17 is located at an outer peripheral side of the outer peripheral surface of the shaft 90, but may be located at an inner peripheral side with respect to the inner peripheral parts 29 and 39 of covers 20 and 30 described later, respectively.

In addition, the expansion part 16 includes a cavity 76. The cavity 76 is disposed at an outer diameter side of the projecting part 17 in the radial direction, and the annular part 19 and the cavity 76 are adjacent to each other in the radial direction.

Referring back to FIG. 4, a space 74 is formed between two adjacent magnetic pole parts 15 in the circumferential direction. As illustrated in FIGS. 3 and 4, the magnet 40 is inserted into the space 74. In addition, as illustrated in FIGS. 4 and 5, the gap 75 is formed between the magnetic pole part 15 and the connection part 12 in the circumferential direction. As illustrated in FIG. 5, the gap 75 is disposed between the air layer 79 and the branch part 52 between the connection part 12 and the magnetic pole part 15.

The rotor 2 according to the embodiment includes ten magnets 40. Note that, hereinafter, when the magnets 40 are distinguished from each other, the magnets 40 may be referred to as magnets 4a to 4j. The magnets 40 in the embodiment are, for example, plate-shaped magnets extending in the axial direction.

As illustrated in FIG. 3, the magnet 40 includes end surface 41 in a radially outer side, side end surface 42 in a radially inner, end surface 43 in a circumferentially counterclockwise- side, and end surface 44 in a circumferentially clockwise-side. Further, as illustrated in FIG. 3, the magnet 40 includes an N-pole 4N and an S-pole 4S. In the present embodiment, two magnets 40 adjacent to each other in the circumferential direction are disposed such that the same poles oppose each other. For example, as illustrated in FIG. 3, two magnets 4a and 4b adjacent to each other in the circumferential direction are disposed such that the N-poles 4N oppose each other. Two magnets 4j and 4a adjacent to each other in the circumferential direction are disposed such that the S-poles 4S oppose each other. Note that end surface 42 in the radially inner side is an example of a surface opposing the gap of the magnet.

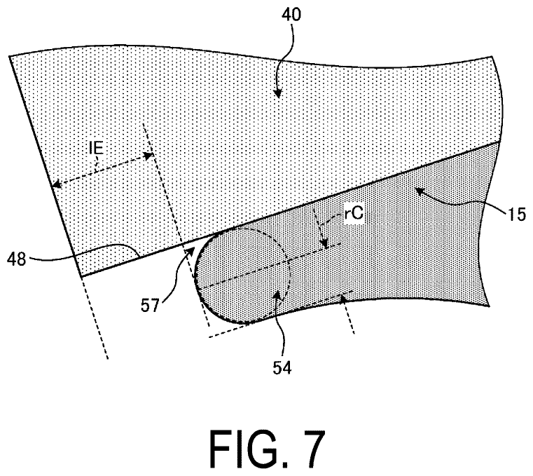

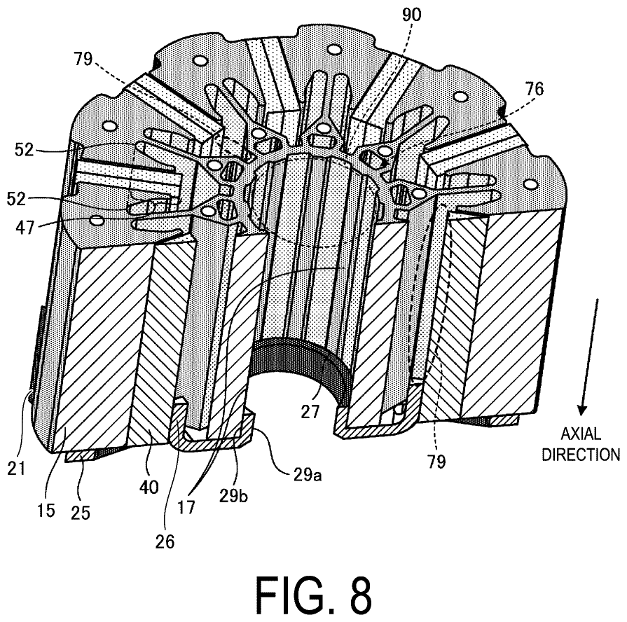

In the embodiment, as illustrated in FIGS. 7 and 8, a part 48 of an inner diameter side 47 of the magnet 40 extends toward the radially inner side of the leading end part 54 of the magnetic pole part 15. FIG. 7 is an enlarged cross-sectional view illustrating an example of the leading end part of the yoke and the extending part of the magnet according to the first embodiment. FIG. 8 is a cross-sectional perspective view illustrating an example of the rotor according to the first embodiment. FIG. 8 illustrates a cross-section taken along plane S3 in FIG. 1. Note that, hereinafter, the part 48 of the inner diameter side 47 of the magnet 40 may be referred to as an extending part 48. In addition, in FIG. 8, an ellipse indicated by a broken line indicates a cross-section of the shaft 90.

As illustrated in FIG. 8, the inner diameter side 47 of the magnet 40 is a part, indicated by a dot-dash line, of the radially inner side than the center part in the radial direction of the magnet 40. For example, the center part of the magnet 40 may be located at substantially the same position as a line connecting the branch parts 52 of two adjacent magnetic pole parts 15 in the circumferential direction. In other words, of the magnet 40, a part on a radially inner side from the line connecting the branch parts 52 of two adjacent magnetic pole parts 15 may be defined as a part of the radially inner side of the magnet 40.

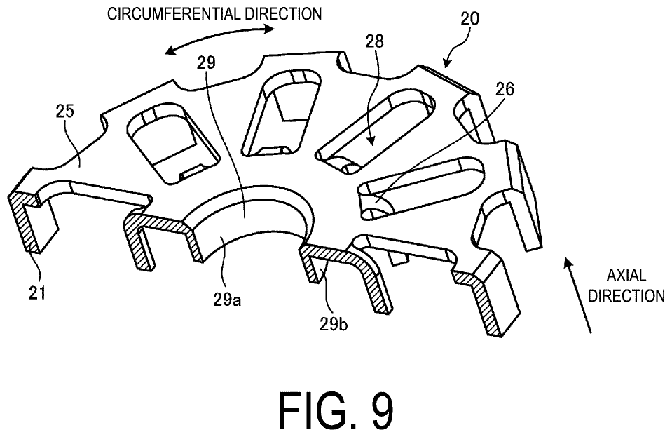

In the rotor 2 illustrated in FIG. 3, the magnet 40 disposed at the yoke 10 may be pushed out to the radially outer side or in the positive or negative direction in the axial direction due to a repulsive force with another magnet 40 adjacent in the circumferential direction or a centrifugal force generated by rotation of the rotor 2. Thus, in the present embodiment, the covers 20 and 30 as illustrated in FIG. 9 are attached to the yoke 10 as illustrated in FIG. 1 to help prevent the magnets 40 from being pushed out. FIG. 9 is a cross-sectional perspective view illustrating an example of the cover according to the first embodiment. As illustrated in FIG. 1, the cover 20 is attached to the yoke 10 from the positive direction side being one side in the axial direction, and the cover 30 is attached to the yoke 10 from the negative direction side being the other side in the axial direction.

As illustrated in FIGS. 8 and 9, the cover 20 includes a plurality of outer peripheral parts 21, a planar part 25, and an inner peripheral part 29. Further, the cover 20 may further include a plurality of opening parts 28. Note that, although the cover 20 is illustrated in FIG. 9, the covers 20 and 30 in the present embodiment have the same shape, and matters described below with respect to the cover 20 also apply to the cover 30 unless otherwise specified. Similarly, matters described with respect to the cover 30 also apply to the cover 20 unless otherwise specified.

In the present embodiment, the cover 20 is made of a non-magnetic material such as brass. Further, the cover 20 may be formed by bending a material, such as austenitic stainless steel, having lower magnetism than the magnetic steel plate constituting the yoke 10.

As illustrated in FIG. 9, each of the outer peripheral parts 21 projects from the planar part 25 in the axial direction. For example, the plurality of outer peripheral parts 21 are formed in line at equal intervals in the circumferential direction. More specifically, as illustrated in FIGS. 1 and 2, the outer peripheral part 21 is formed at a position in contact with a part of the magnet 40. For example, the outer peripheral part 21 is formed at a position in contact with a part of the axially positive direction side of the end surface 41, and the same number of the outer peripheral parts 21 as the number of magnets 40 are formed.

Each of the outer peripheral parts 21 of the cover 20 projects toward the axially negative direction side, and each of the outer peripheral parts 31 of the cover 30 projects toward the axially positive direction side. In this case, of end surface 41 in the radially outer side of the magnet 40, a part on the axially positive direction side is in contact with the outer peripheral part 21 of the cover 20, and a part on the axially negative direction side is in contact with the outer peripheral part 31 of the cover 30.

The opening parts 28 are formed extending through the planar part 25 in the axial direction. As illustrated in FIG. 1, the opening parts 28 oppose end surfaces 45 in axially positive direction side of the magnets 40. In this case, as illustrated in FIG. 1, the magnets 40 are visually recognized from the axially positive direction side via the opening parts 28.

The inner peripheral part 29 projects from the planar part 25 in the axial direction, in the same manner as the outer peripheral parts 21. The outer diameter of the inner peripheral part 29 is, for example, substantially the same as or slightly larger than the inner diameter of the projecting part 17 of the yoke 10. In addition, the inner diameter of the inner peripheral part 29 is, for example, substantially the same as or slightly smaller than the outer diameter of the shaft 90. In such a configuration, for example, the covers 20 and 30 are press-fitted and inserted into the projecting part 17 of the yoke 10 in the radial direction. Then, the shaft 90 is press-fitted and inserted into the inner peripheral part 29.

As illustrated in FIGS. 8 and 9, the inner peripheral part 29 includes a surface 29a engaging with the shaft 90 and a surface 29b engaging with the projecting part 17. Note that the inner peripheral part 29 is an example of a part of the cover.

Support parts 26 project from the planar part 25 in the axial direction, in the same manner as the outer peripheral parts 21 and the inner peripheral part 29. For example, in the same manner as the outer peripheral parts 21, the support parts 26 are formed in line at equal intervals in the circumferential direction, opposing the magnets 40 in the radial direction, and the same number of the support parts 26 as the number of the magnets 40 are formed. In addition, the opening parts 28 extending through the planar part 25 in the axial direction are formed around the support parts 26. In the embodiment, the support parts 26 of the cover 20 project toward the axially negative direction side, and the support parts 36 of the cover 30 project toward the axially positive direction side.

The support parts 26 and 36 are each in contact with end surface 42 in the radially inner side of the magnet 40. As illustrated in FIG. 8, the support parts 26 are inserted into the air layers 79 of the yoke 10 from the axially positive direction side. The support part 26 supports end surface 42 in the radially inner side of the magnet 40 from the radially inner side. In such a configuration, the magnet 40 is supported in the radial direction by the outer peripheral part 21 and the support part 26 of the cover 20, and the outer peripheral part 31 and the support part 36 of the cover 30.

In this case, since the projecting part 17 of the yoke 10 projects toward the inner diameter side from the inner peripheral part 29 of the cover 20, when the cover 20 is press-fitted, stress pressing the projecting part 17 toward the radially outer side is applied to the contact surface 27 between the projecting part 17 and the surface 29b of the inner peripheral part 29 illustrated in FIG. 8.

In the present embodiment, the projecting part 17 and the outer peripheral surface 53 are opposed to each other in the radial direction via the cavity 76. Thus, the stress applied to the projecting part 17 is absorbed by the cavity 76. This suppresses deterioration of the circularity of the yoke 10 due to deformation caused by the stress transferred to the outer peripheral surface 53.

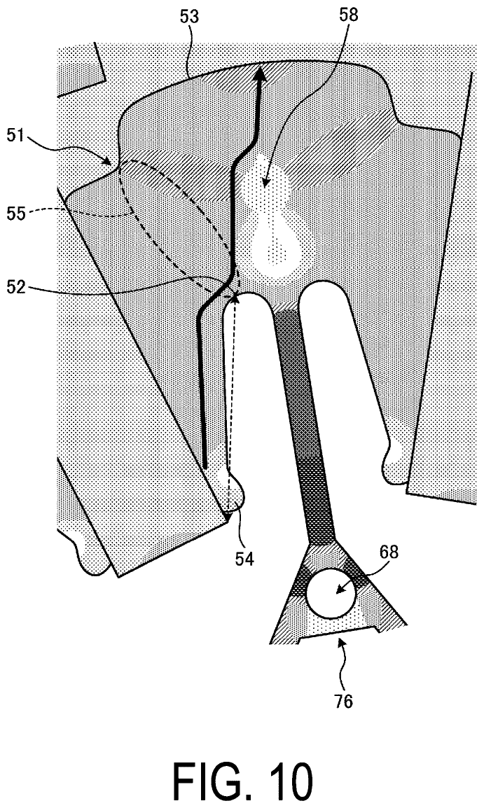

In such a configuration, the magnetic flux on the inner diameter side of the magnet 40 passes through the outer peripheral surface 53 of the magnetic pole part 15. Specifically, the magnetic flux flowing from the inner diameter side of the magnet 40 flows to the outer peripheral surface 53 of the magnetic pole part 15, as indicated by the arrow in FIG. 10. FIG. 10 is a view explaining an example of a flow of the magnetic flux according to the first embodiment. FIG. 10 is an enlarged view of the part indicated by frame F3 in FIG. 3. Then, the magnetic flux passes through a magnetic path 55 formed between the recessed part 51 and the branch part 52 of the magnetic pole part 15 and flows to the outer peripheral surface 53. At this time, as illustrated in FIG. 10, the magnetic flux bypasses the rivet part 58 tending to have magnetic flux saturation. As a result, the magnetic flux on the inner diameter side 47 of the magnet 40 illustrated in FIG. 8 flows toward the radially outer side of the rotor 2.

As described above, the motor 1 according to the embodiment includes the shaft 90, the stator 80, and the rotor 2. The rotor 2 includes the yoke 10 and the magnet 40. The yoke 10 includes the annular part 19 disposed at the radially inner side, the magnetic pole part 15 disposed at the radially outer side and being in contact with the magnet 40, the connection part 12 connecting the annular part 19 and the magnetic pole part 15, and the gap 75 formed between the magnetic pole part 15 and the connection part 12 in the circumferential direction. The magnetic flux at the inner diameter side of the magnet 40 passes through the outer peripheral surface 53 of the magnetic pole part 15. According to such a configuration, the magnetic flux at the inner diameter side of the magnet 40 can also be interlinked with the stator located at the radially outer side of the rotor 2, so that motor characteristics can be improved.

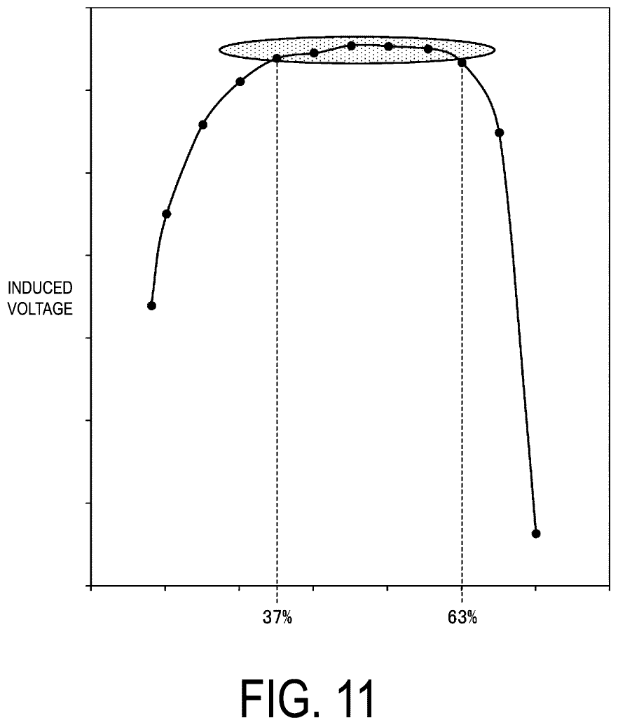

In the embodiment, a length 1A of the longest line segment connecting a corner part 49, located at the inner diameter side of the end surface 42 of the magnet 40 opposing the gap 75, and a part 52 is preferably 37% or more and 63% or less of a length 1M of the magnet 40 in the radial direction. At the part 52, the connection part 12 branches off from the magnetic pole part 15. FIG. 11 is a graph showing an example of the relationship between the size of the gap and the motor characteristics according to the first embodiment. In FIG. 11, the horizontal axis represents the ratio of the length 1A of the line segment to the length 1M of the magnet 40, and the vertical axis represents an induced voltage of the motor 1. As shown in FIG. 11, the motor 1 can ensure a sufficient induced voltage in a range with the ratio of the length 1A to the length 1M being 37% or more and 63% or less. Note that the relationship between the ratio of the lengths and the motor characteristics as shown in FIG. 11 is substantially the same even when the size of the rotor 2 is changed.

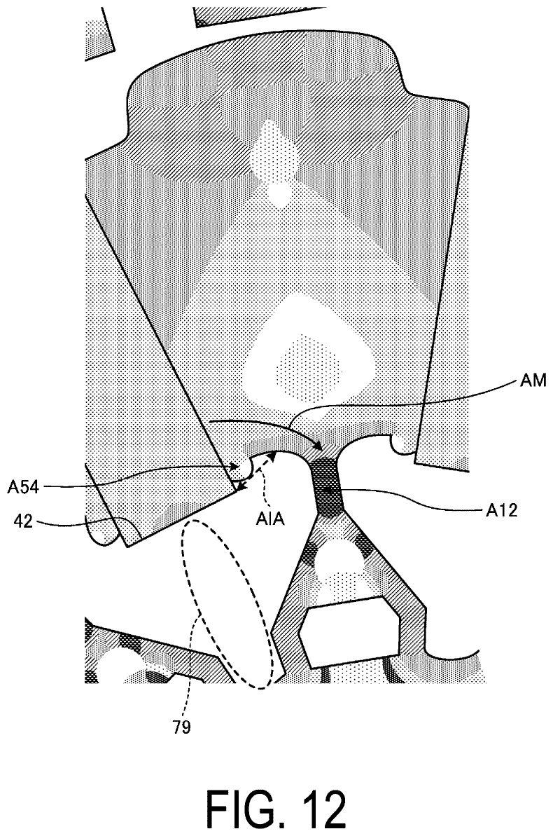

When the length 1A of the line segment is short, for example, when the ratio of a length A1A of the line segment to the length 1M of the magnet 40 is less than 37% as illustrated in FIG. 12, the length of the magnetic path from a leading end part A54 to a connection part A12 is small, thus reducing magnetic resistance on the inner diameter side. FIG. 12 is a view explaining an example of a flow of the magnetic flux according to a comparative example. FIG. 12 illustrates a case of the ratio of the length A1A of the line segment to the length 1M of the magnet 40 being, for example, 15%. In this case, even when the end surface 42 on the inner diameter side of the magnet 40 opposes the air layer 79, magnetic flux leakage from the inner diameter side of the magnet 40 increases, as indicated by an arrow AM. As a result, as shown in the graph in FIG. 11, the induced voltage of the motor 1 decreases.

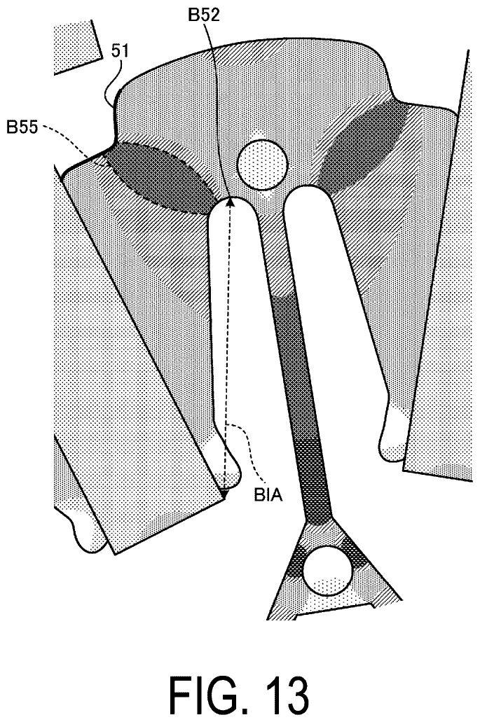

On the other hand, when the length 1A of the line segment is long, for example, when the ratio of a length BIA of the line segment to the length 1M of the magnet 40 exceeds 63% as illustrated in FIG. 13, a magnetic path B55 formed between the recessed part 51 of the magnetic pole part 15 and a branch part B52 becomes narrow. FIG. 13 is a view explaining an example of a flow of the magnetic flux according to another comparative example. In this case, magnetic path resistance at the magnetic path B55 increases, and magnetic saturation occurs, making it difficult for the magnetic flux from the inner diameter side of the magnet 40 to travel toward the outer peripheral surface 53 of the magnetic pole part 15. As a result, as shown in the graph in FIG. 11, the induced voltage of the motor 1 decreases. Note that FIG. 13 illustrates a case of the ratio of the length 1A of the line segment to the length 1M of the magnet 40 being, for example, 80%.

Note that, from the viewpoint of lowering the GD2 (moment of inertia) of the rotor 2, a cutout of the gap 75 is preferably large, that is, the ratio of the length 1A of the line segment to the length 1M of the magnet 40 is preferably close to 63%.

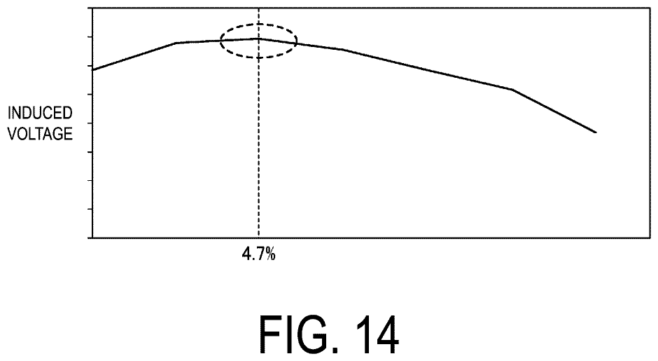

Further, a length 1E in the radial direction of the extending part 48 of the magnet 40 illustrated in FIG. 7 is preferably around 4.7% of the length 1M of the magnet 40, as shown in FIG. 14. FIG. 14 is a graph showing an example of the relationship between the length of the radius of the leading end part of the magnetic pole part and the motor characteristics according to the first embodiment. In the present embodiment, when the length 1E of the extending part 48 is excessively short, magnetic flux leakage to the inner diameter side increases, and when the length 1E is excessively long, the magnetic path resistance at the leading end part 54 increases. Thus, the length 1E of the extending part 48 in the radial direction is preferably in a range of 2% to 6% of the length 1M of the magnet 40 in the radial direction.

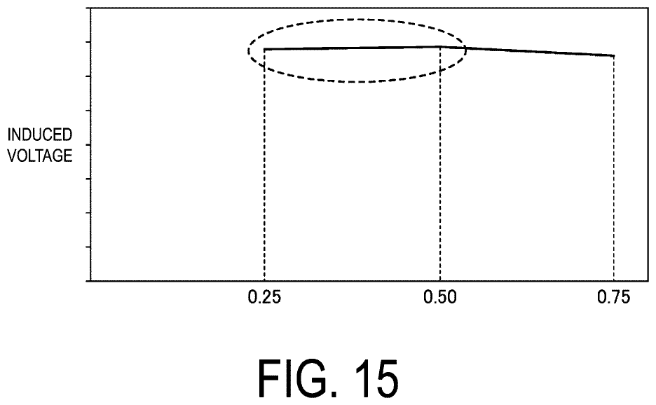

A radius rB of the branch part 52 illustrated in FIG. 5 is preferably within a range of 3.7% to 6.8% of the length 1M of the magnet 40, as shown in FIG. 15. FIG. 15 is a graph showing an example of the relationship between the length of the radius of the branch part and the motor characteristics according to the first embodiment.

In the present embodiment, the steel plate core constituting the yoke 10 is formed by punching an electromagnetic steel sheet with a press, for example. At this time, as illustrated in FIG. 7, a chamfer 57 is formed at the leading end part 54 in the circumferential direction. Note that the chamfer 57 is an example of a part separating from the magnet 40.

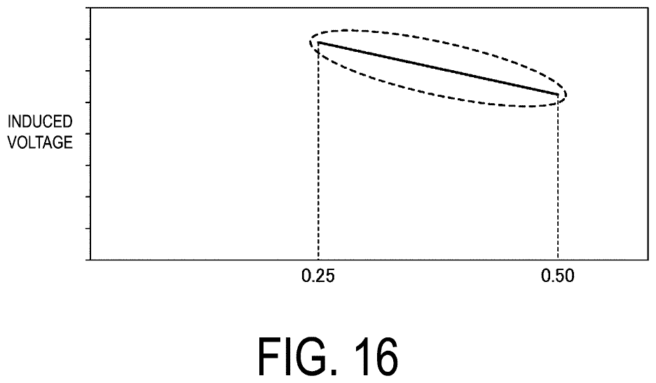

In this case, the thickness of the leading end part 54 of the magnetic pole part 15 in the circumferential direction is determined according to a radius rC of the chamfer 57 formed in an arc shape illustrated in FIG. 7. In the present embodiment, the radius rC is preferably equal to or less than 0.5 mm as shown in FIG. 16. FIG. 16 is a graph showing an example of the relationship between the length of the extending part of the magnet and the motor characteristics according to the first embodiment. As shown in FIG. 16, as the radius rC of the chamfer 57 becomes smaller, the magnetic flux leakage to the inner diameter side is suppressed, and motor characteristics are improved. In the present embodiment, 0.25 mm is desirable in consideration of manufacturing limitations.

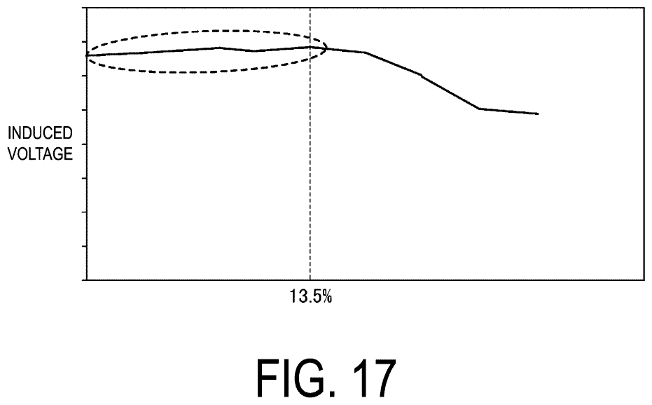

Further, a length ID in the radial direction of the leading end part 54 of the magnetic pole part 15 illustrated in FIG. 5 is preferably around 13.5% of the length 1M of the magnet 40, as shown in FIG. 17. FIG. 17 is a graph showing an example of the relationship between the length of the leading end part of the magnetic pole part and the motor characteristics according to the first embodiment. As shown in FIG. 17, when the ratio of the length ID of the leading end part 54 exceeds 13.5%, magnetic saturation is likely to occur at the leading end part 54.

Although the configuration of each embodiment has been described above, no limitation is intended. For example, the shape of the yoke 10 is merely an example, and the dimensions and the like of each part may be appropriately changed within the preferable range described above. In addition, the support parts 26 and 36 respectively of the covers 20 and 30 may be formed by different members. In addition, the covers 20 and 30 may not include the opening parts 28 and 38, respectively.

In the present embodiment, end surfaces 45 in the axially positive direction side of the magnets 40 illustrated in FIG. 1 are formed so as to be substantially flush with an axially positive direction side end face of the yoke 10, but no limitation is intended. For example, the end surfaces 45 may be projected from the end surface of the yoke 10 in the axial direction, or end surface in the axially positive direction side of the yoke 10 may be projected from end surfaces 45 in the axially positive direction side of the magnets 40. That is, in the present embodiment, the length of the magnet 40 in the axial direction is substantially the same as the length of the yoke 10 in the axial direction, but no limitation is intended. According to such a configuration, since the magnets 40 are fixed to the shaft 90 by the covers 20 and 30 regardless of the length of the yoke 10, it is possible to suppress a change in press-fit assembly force and holding force in fixing the magnet 40 to the shaft 90. In addition, the magnetic flux leakage of the magnets 40 to the yoke 10 can be suppressed.

Although the present invention has been described above on the basis of the embodiments and each modification, the present invention is not limited to the embodiments and each modification, and it goes without saying that various variations can be made without departing from the gist of the present invention. Various variations without departing from such gist are also included in the technical scope of the present invention, and this is apparent to those skilled in the art from the description of the claims.

### REFERENCE SIGNS LIST

### 1 Motor,

### 2 Rotor,

### 10 Yoke,

12 Connection part,
15 Magnetic pole part,
16 Expansion part,
17 Projecting part,
19 Annular part,

### 20, 30 Cover,

21, 31 Outer peripheral part,
25, 35 Planar part,
26, 36 Support part,
28, 38 Opening part,
29, 39 Inner peripheral part,

### 40 Magnet,

41 Outer peripheral side end surface,
42 end surface in the inner peripheral side,
43, 44 Side surface,
48 Extending part,
49 Corner part,
51 Recessed part,
52 Branch part,
53 Outer peripheral surface,
54 Leading end part,

### 57 Chamfer,

58, 68 Rivet part,

### 74 Space,

### 75 Gap, 76 Cavity,

79 Air layer,

### 80 Stator,

### 90 Shaft

1. A motor comprising:
a shaft;
a stator; and
a rotor, wherein
the rotor includes:
a yoke; and
a magnet,
the yoke includes:
an annular part disposed at an inner side in a radial direction;
a magnetic pole part disposed at an outer side in a radial direction, the magnetic pole part being in contact with the magnet;
a connection part connecting the annular part and the magnetic pole part; and
a gap formed between the magnetic pole part and the connection part in a circumferential direction, and
a magnetic flux at an inner side of the magnet in a radial direction passes through an outer peripheral surface of the magnetic pole part.

2. The motor according to claim 1, wherein
the magnet includes a corner part located at an inner side of a surface opposing the gap,
the connection part includes a part branched off from the magnetic pole part, and
a length of a longest line segment connecting the corner part and the part branched off from the magnetic pole part is 37% or more of a length of the magnet in the radial direction.

3. The motor according to claim 2, wherein the length of the longest line segment is 63% or less of the length of the magnet in the radial direction.

4. The motor according to claim 2, wherein the magnet includes an extending part at an inner peripheral side in a radial direction, the extending part being located at an inner peripheral side with respect to an end part in an inner peripheral side of the magnetic pole part.

5. The motor according to claim 4, wherein a length of the extending part in the radial direction is in a range of 2% to 6% of a length of the magnet in the radial direction.

6. The motor according to claim 2, wherein
the magnetic pole part includes a leading end part projecting in an inner direction, and
a length of the leading end part is 13.5% or less of the length of the magnet in the radial direction.

7. The motor according to claim 6, wherein the leading end part includes a part separating from the magnet in a circumferential direction.

8. The motor according to claim 1, wherein
the stator is located at an outer peripheral side of the rotor in the radial direction,
the shaft is located at an inner peripheral side of the rotor in the radial direction,
the rotor further includes a cover covering the yoke from an outer side in the axial direction,
the annular part includes a projecting part projecting toward the inner peripheral side in the radial direction, and
a part of the cover includes a surface engaging with the projecting part and a surface engaging with the shaft.

9. The motor according to claim 1, wherein
the connection part includes a part expanding in the circumferential direction, and
the part of the connection part includes a cavity.

10. The motor according to claim 9, wherein
the annular part includes a projecting part projecting toward an inner peripheral side in a radial direction,
the cavity is disposed at an outer side of the projecting part in the radial direction, and
the annular part and the cavity are adjacent to each other in the radial direction.
